(19) United States
(12) Patent Application Publication
(10) Pub. No.: US 2012/0201563 A1
(43) Pub. Date: Aug. 9, 2012

(54) Image Forming Apparatus, Latent Image Carrying Unit, and Developing Unit

(75) Inventors: Kazuma MIYAZAWA, Shiojiri-shi (JP); Tsutomu SASAKI, Matsumoto-shi (JP); Hidehiro TAKANO, Matsumoto-shi (JP); Michio SATO, Okaya-shi (JP); Naoyuki OKUMURA, Shimosuwa-machi (JP); Satoru MIYAMOTO, Matsumoto-city (JP); Ken IKUMA, Suwa-shi (JP)

(73) Assignee: SEIKO EPSON CORPORATION, Tokyo (JP)

(21) Appl. No.: 13/361,909

(22) Filed: Jan. 30, 2012

(30) Foreign Application Priority Data
Feb. 9, 2011 (JP) 2011-025937
Feb. 17, 2011 (JP) 2011-031922

(51) Int. Cl. G03G 21/00

(52) U.S. Cl. 399/92

(57) ABSTRACT

Provided is an image forming apparatus including: a latent image carrying drum on which a latent image is formed; a charging section that includes a corona charger charging the latent image carrying drum and an air flow duct formed in the corona charger so as to be long in the rotation axis direction of the latent image carrying drum so that air flows in the corona charger; a developing section that is disposed above the air flow duct in the vertical direction, is formed so as to be shorter than the air flow duct in the rotation axis direction of the latent image carrying drum, and develops the latent image formed on the latent image carrying drum by a liquid developing agent including toner and a carrier liquid.

### BACKGROUND

1. Technical Field

The present invention relates to an image forming apparatus that forms an image by developing the image using a liquid developing agent including a carrier liquid and toner particles and relates to a latent image carrying unit and a developing unit.

2. Related Art

Hitherto, a liquid developing type image forming apparatus has been practically used, in which an electrostatic latent image is formed on a charged photoreceptor and a toner image is formed by developing the electrostatic latent image using a liquid developing agent obtained by dispersing toner particles in a carrier liquid. For example, in an image forming apparatus disclosed in JP-A-9-15980 (FIG. 1), an oil pan is attached to an apparatus main body and developing equipment is loaded on the oil pan so as to perform the developing process. Such a configuration is adopted so as to prevent occurrence of a problem in which a liquid developing agent leaks from the developing equipment and is dispersed inside the apparatus.

As described above, the oil pan serves as an independent component attached to the apparatus main body, which is a main factor that restricts the arrangement space for the respective components of the apparatus and degrades the degree of freedom in design. Further, in order to realize a simple function of receiving the liquid developing agent leaking from the developing equipment, the independent component needs to be installed, which is a factor that increases the cost of the apparatus.

### SUMMARY

An advantage of some aspects of the invention is that it provides a technique capable of preventing the inside of the apparatus from being contaminated by reliably collecting the liquid developing agent leaking from the developing section while saving space and reducing cost.

According to a first aspect of the invention, there is provided an image forming apparatus including: a latent image carrying drum on which a latent image is formed; a charging section that includes a corona charger charging the latent image carrying drum and an air flow duct formed in the corona charger so as to be long in the rotation axis direction of the latent image carrying drum and making air flow in the corona charger; and a developing section that is disposed above the air flow duct in the vertical direction, is formed so as to be shorter than the air flow duct in the rotation axis direction of the latent image carrying drum, and develops the latent image formed on the latent image carrying drum by a liquid developing agent including toner and a carrier liquid.

Further, according to a second aspect of the invention, there is provided a latent image carrying unit including: a latent image carrying drum on which a latent image is formed; a charging section that includes a corona charger charging the latent image carrying drum and an air flow duct formed in the corona charger so as to be long in the rotation axis direction of the latent image carrying drum and making air flow in the corona charger; and a developing section that is disposed above the air flow duct in the vertical direction, is formed so as to be shorter than the air flow duct in the rotation axis direction of the latent image carrying drum, and develops the latent image formed on the latent image carrying drum by a liquid developing agent including toner and a carrier liquid.

In the image forming apparatus and the latent image carrying unit with such a configuration, the developing section extends in the rotation axis direction so as to develop the latent image on the latent image carrying drum using the liquid developing agent, and the liquid developing agent leaking from the developing section is dispersed in the rotation axis direction and drops downward in the vertical direction. Then, when the liquid developing agent is dispersed inside the apparatus, the inside of the apparatus is contaminated, which induces various troubles. However, in a case where the developing section is installed so as to be positioned above the upper surface of the charging air flow member in the vertical direction, that is, the upper surface of the charging air flow member is present below the developing section in the vertical direction, as in the aspect of the invention, the upper surface of the charging air flow member is formed so as to be longer than the charging member and the developing section in the rotation axis direction of the latent image carrying drum. Accordingly, the ambient atmosphere of the entire charging member is reliably ventilated and the liquid developing agent leaking and dropping from the developing section is received by the upper surface of the charging air flow member, thereby reliably preventing the inside of the apparatus from being contaminated by the liquid developing agent.

### BRIEF DESCRIPTION OF THE DRAWINGS

The invention will be described with reference to the accompanying drawings, wherein like numbers reference like elements.

FIG. 1 is a diagram illustrating a first embodiment of an image forming apparatus according to the invention.

FIG. 2 is a perspective view illustrating the arrangement relationship between a charging section and a developing section.

FIG. 3 is a cross-sectional view illustrating the relationship of the dimensions and the arrangement between the charging section and the developing section.

FIG. 4 is a diagram illustrating a second embodiment of the image forming apparatus according to the invention.

FIG. 5 is a diagram illustrating a third embodiment of the image forming apparatus according to the invention.

FIG. 6 is a diagram illustrating a fourth embodiment of the image forming apparatus according to the invention.

FIG. 7 is a diagram illustrating a fifth embodiment of the image forming apparatus according to the invention.

FIG. 8 is a diagram illustrating a sixth embodiment of the image forming apparatus according to the invention.

FIG. 9 is a diagram illustrating a seventh embodiment of the image forming apparatus according to the invention.

FIG. 10 is a perspective view illustrating the arrangement relationship between the charging section and the developing section.

FIG. 11 is a perspective view illustrating the outline configuration of a cleaning mechanism in the developing section.

FIG. 12 is a schematic diagram illustrating a collection path of a waste liquid which is collected by a cleaning mechanism.

FIGS. 13A and 138 are diagrams illustrating the operation of positioning the developing section to a contact position and a separation position.

FIG. 14 is a diagram illustrating the operation of positioning the developing section to a maintenance position.

FIGS. 15A and 15B are partially enlarged views illustrating the configuration of a moving mechanism and a movement regulating mechanism.

FIGS. 16A to 16C are diagrams illustrating the configuration of an adjusting mechanism.

FIG. 17 is a diagram illustrating an eighth embodiment of the image forming apparatus according to the invention.

### DESCRIPTION OF EXEMPLARY EMBODIMENTS

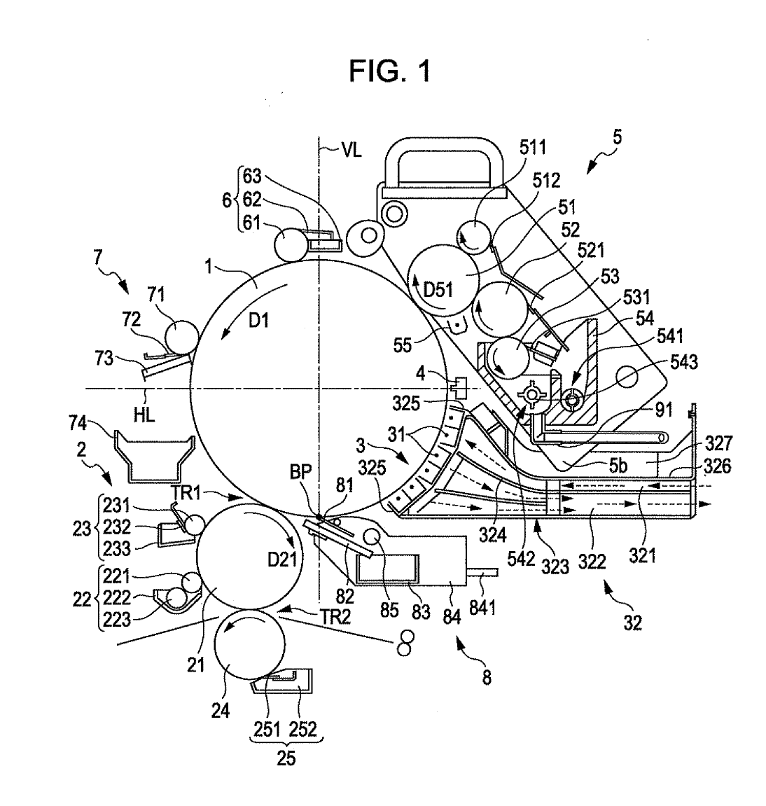

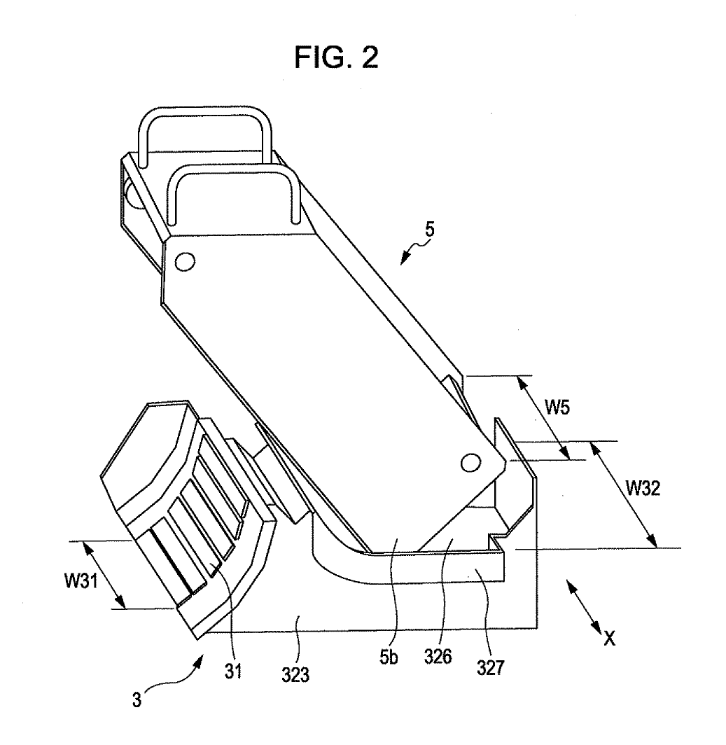

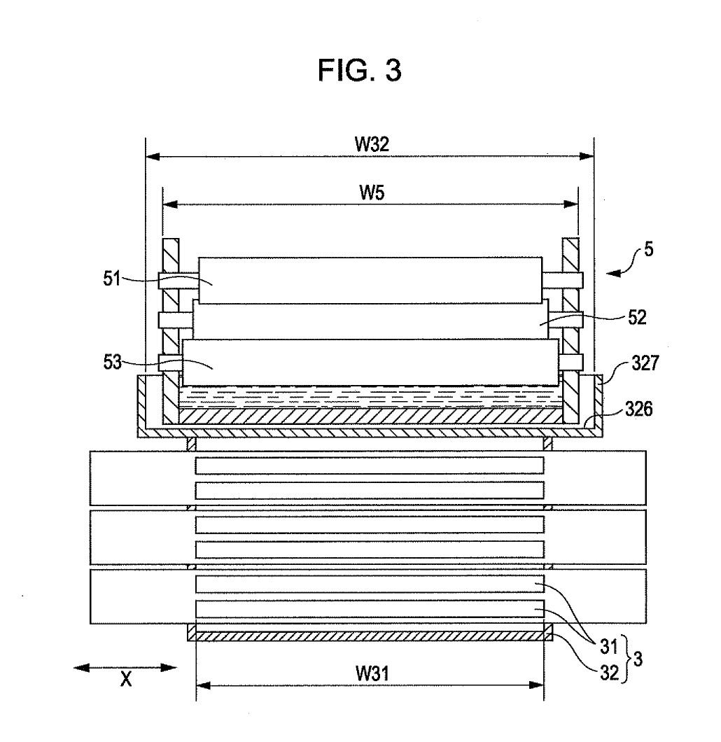

Hereinafter, the first and second aspects of the invention will be described. FIG. 1 is a diagram illustrating a first embodiment of an image forming apparatus according to the invention. FIG. 2 is a perspective view illustrating the arrangement relationship between a charging section and a developing section. FIG. 3 is a cross-sectional view illustrating the relationship of the dimensions and the arrangement between the charging section and the developing section. The image forming apparatus has a so-called lower transfer structure which is installed below the virtual horizontal line HL passing through the rotation center of a photosensitive drum 1 in the vertical direction. That is, in this structure, an image which is carried on a photosensitive drum 1 is transferred to a blanket roller 21 of a primary transfer section 2 and the image which is transferred to the blanket roller 21 is transferred to transfer paper. Furthermore, as described below, the image forming apparatus of FIG. 1 is configured to form a monochrome toner image and transfer the toner image onto transfer paper. Here, a color printing system may be configured by arranging, for example, four image forming apparatuses. Of course, each apparatus of FIG. 1 also serves as a monochrome image forming apparatus.

In the image forming apparatus, the surface of the photosensitive drum 1 is provided with a photosensitive layer which is formed of a photosensitive material such as amorphous silicon photoreceptor. Then, the photosensitive drum 1 is disposed so that the rotary shaft thereof is parallel to or substantially parallel to the main-scanning direction (the direction perpendicular to the drawing paper of FIG. 1), and is rotationally driven at a predetermined speed in the direction depicted by the arrow D1 of FIG. 1.

In the circumference of the photosensitive drum 1, the following sections are arranged in the rotation direction D1 of the photosensitive drum 1 (in FIG. 1, the counter-clockwise direction) in order to be mentioned below. The following sections include: a charging section 3 which charges the surfaces of the photosensitive drum 1 to a predetermined potential; an exposure section 4 which forms an electrostatic latent image by exposing the surface of the photosensitive drum 1 in accordance with image signals; a developing section 5 which forms a toner image by developing the electrostatic latent image using a liquid developing agent; a first squeeze section 6; a second squeeze section 7; the blanket roller 21 of the primary transfer section 2; and a photoreceptor cleaning section 8 which cleans the surface of the photosensitive drum 1 after the primary transfer process.

The charging section 3 includes six chargers 31 and a charger air flow duct 32. In the drawing paper of FIG. 1, the charging section 3 is disposed at the right side of the virtual vertical line VL passing through the rotation center of the photosensitive drum 1 and below the virtual horizontal line HL passing through the rotation center of the photosensitive drum 1 in the vertical direction. Six chargers 31 are arranged along the rotation direction D1 of the photosensitive drum 1 so as not to come into contact with the surface of the photosensitive drum 1. As the charger 31, for example, a generally known corona charger may be used. In a case where a scorotron charger is used in the corona charger, a wire current flows to the charge wire of the scorotron charger and a grid charging bias of a direct current (DC) is applied to the grid. In this way, the potential of the surface of the photosensitive drum 1 is set to a substantially uniform potential in a manner such that the photosensitive drum 1 is charged by the corona charging process using the charger 31.

Further, the charger air flow duct 32 includes an external air introduction path 321 which introduces external air toward the charger 31 and an exhaust path 322 which discharges the ambient atmosphere of the charger 31 generated by the discharging process in the charger 31. Then, the atmosphere is managed by making air flow in the charger 31 in a manner such that the air flow is generated in the atmosphere where the charging process is performed and the exhaust operation is performed. Furthermore, the charger air flow duct 32 has a function of receiving and collecting a liquid developing agent exiting and dropping from the developing section 5 in addition to such a function of ventilating the ambient atmosphere of the charger 31. However, the specific configuration and effect will be described later in detail.

The exposure section 4 is disposed at the right side of the virtual vertical line VL of the drawing paper of FIG. 1 and on the virtual horizontal line HL. The exposure section 4 is configured to form an electrostatic latent image corresponding to image signals by exposing the surface of the photosensitive drum 1 using an optical beam in accordance with the image signals transmitted from an external device. In the embodiment, as the exposure section 4, a line head in which light emitting elements are arranged in the main-scanning direction (the direction perpendicular to the drawing paper of FIG. 1) is used. In addition, a section which scans the main-scanning direction using an optical beam generated from a semiconductor laser using a polygon mirror may be used. Furthermore, in the embodiment, the exposure section 4 is disposed on the virtual horizontal line HL, but the arrangement position of the exposure section 4 is not limited thereto. For example, the exposure section may be disposed above or below the virtual horizontal line HL in the vertical direction.

The liquid developing agent is applied from the developing section 5 to the electrostatic latent image formed in this way, and the electrostatic latent image is developed by toner. In the embodiment, a liquid developing agent is used in which colored resin particles serving as toner particles with a weight ratio of approximately 25% is dispersed inside a carrier liquid mainly containing an insulating liquid. Here, the toner particles have charges so that the charges may be electrophoresed in the electric field. Furthermore, the concentration of the developing agent is not limited to 25%, but may be in the range of 10 to 30%. Further, as the carrier liquid, for example, Isopar (the trademark of Exxon Corporation), silicon oil, normal paraffin oil, or the like is used. Further, the electrical resistance is 10¹⁰ Ω·cm or more and desirably 10¹² Ω·cm or more. This is because an excessive current flows and an electric field necessary for the movement may not be maintained during a process in which the toner particles are electrophoresed when the resistance is low. Furthermore, the viscosity of the liquid developing agent which is produced in this way is dependent on a resin forming the toner particles or a dispersing agent and a charge control agent. However, a liquid developing agent which has a viscosity of 50 to 500 [Pa·s] may be used, and in the embodiment, a liquid developing agent of 400 [Pa·s] is used.

The developing section 5 of the image forming apparatus is disposed at the right side of the virtual vertical line VL of the drawing paper of FIG. 1 and above the charging section 3 in the vertical direction, and mainly includes: a developing roller 51; an intermediate coating roller 52; an anilox roller 53; a developing agent container 54 which stores the above-described liquid developing agent; and a toner compressing corona generator 55 which performs a charging and compressing action on the liquid developing agent. In these main components, the developing roller 51 is a cylindrical member, and an elastic layer such as polyurethane rubber, silicon rubber, NBR, or a PFA tube is formed on the outer peripheral portion of an inner core formed of metal such as iron. The developing roller 51 is connected to a developing motor (not shown), and is rotationally driven in the clockwise direction D51 of the drawing paper of FIG. 1 so as to rotate in the complementary direction with respect to the photosensitive drum 1. Further, the developing roller 51 is electrically connected to a developing bias generating section (not shown), and is configured to apply a developing bias at an appropriate timing.

Further, the intermediate coating roller 52 and the anilox roller 53 are installed so as to supply the liquid developing agent to the developing roller 51, and the liquid developing agent is supplied from the anilox roller 53 to the developing roller 51 through the intermediate coating roller 52. In these rollers, the intermediate coating roller 52 has a configuration in which an elastic layer is formed on an outer peripheral portion of a metallic inner core as in the developing roller 51. On the contrary, the anilox roller 53 is a roller of which a surface is provided with a concave pattern such as a spiral groove that is minutely and evenly carved so as to easily store the liquid developing agent therein. Of course, the anilox roller 53 may have a configuration in which a rubber layer such as urethane or NBR is wound on a metallic core or a PFA tube is coated thereon as in the developing roller 51 or the intermediate coating roller 52. The intermediate coating roller 52 and the anilox roller 53 are connected to the above-described developing motor, and respectively rotate in the clockwise direction and the counter-clockwise direction in the drawing paper of FIG. 1. Accordingly, the intermediate coating roller 52 rotates in the counter direction with respect to the developing roller 51, and the anilox roller 53 rotates in the complementary direction with respect to the intermediate coating roller 52. In this way, in the embodiment, since the liquid developing agent is supplied from the developing agent container 54 to the developing roller 51 by the so-called three-roller structure, when the liquid developing agent passes through the nip multiple times, the liquid developing agent may be sufficiently kneaded and a uniform film of the liquid developing agent may be formed in the developing roller 51. Of course, the invention is not limited to this structure, and a structure (a two-roller structure) in which the liquid developing agent is directly coated on the developing roller 51 from the anilox roller 53 may be adopted.

Further, a cleaning roller 511 comes into contact with the developing roller 51, and a roller cleaning blade 512 comes into contact with the cleaning roller 511, thereby performing a cleaning process on the developing roller 51. That is, the cleaning roller 511, which is installed at the downstream of the developing position where the surface of the developing roller 51 comes into contact with the photosensitive drum 1 so as to form a developing nip therebetween in the rotation direction D51 of the developing roller, rotates in the clockwise direction of the drawing paper of FIG. 1 while coming into contact with the surface of the developing roller 51. Accordingly, the cleaning roller 511 rotates in the counter direction with respect to the developing roller 51, and removes the liquid developing agent which does not contribute to the developing process and remains on the developing roller 51. Further, the roller cleaning blade 512 comes into contact with the surface of the cleaning roller 511 so that the liquid developing agent is scraped out and dropped therefrom to be removed. Further, a cleaning blade 521 comes into contact with the intermediate coating roller 52 so that the liquid developing agent which does not contribute to the developing process and remains on the intermediate coating roller 52 is scraped out and dropped from the surface of the intermediate coating roller 52 to be removed. Furthermore, the liquid developing agent which is scraped out and dropped by such cleaning blades 512 and 521 is guided and collected to a collection portion 541 of the developing agent container 54.

On the other hand, a regulation member 531 comes into contact with the anilox roller 53. As the regulation member 531, a metallic member or an elastic member which is formed by coating an elastic material on the surface thereof may be used. However, the regulation member 531 according to the embodiment includes a rubber portion which is formed of urethane rubber or the like and comes into contact with the surface of the anilox roller 53 and a plate which is formed of metal and supports the rubber portion. Then, the regulation member 531 has a function of adjusting the film thickness, the amount, or the like of the liquid developing agent which is conveyed while being carried on the anilox roller 53 and of adjusting the amount of the liquid developing agent supplied to the developing roller 51. Further, the liquid developing agent which is scraped out by the regulation member 531 is returned to a storage portion 542 of the developing agent container 54. Furthermore, a stirring member 543 is disposed in the storage portion 542, and rotates by a motor (not shown) so that the liquid developing agent is stirred inside the storage portion 542.

With the above-described configuration, the developing roller 51 to which the liquid developing agent is supplied rotates so as to move in the direction opposite to the direction of the surface of the intermediate coating roller 52, and rotates so as to move in the same direction as the direction of the surface of the photosensitive drum 1. Furthermore, in order to form the toner image, the rotation direction of the developing roller 51 needs to be the complementary direction so that the surface rotates in the same direction as that of the surface of the photosensitive drum 1, but may be the opposite direction, the same direction, or any direction with respect to the intermediate coating roller 52.

Further, the toner compressing corona generator 55 is disposed along the rotation direction of the developing roller 51. More specifically, the toner compressing corona generator 55 is disposed at the upstream side of the developing position in the developing roller rotation direction D51. The toner compressing corona generator 55 is an electric field applying section which increases the bias of the surface of the developing roller 51. The electric field is applied to a position where the toner of the liquid developing agent which is conveyed by the developing roller 51 approaches the toner compressing corona generator 55, and the charging and compressing process is performed. Furthermore, in the toner charging and compressing process, a compaction roller performing a charging process through a contact may be used instead of the corona discharging process through the application of electrolyzation.

Further, the developing section 5 with such a configuration is connected to a developing equipment separating and contacting mechanism (not shown). When a control command is transmitted from a controller 10 to the developing equipment separating and contacting mechanism, the developing section 5 may reciprocate between a developing position (a position depicted by the solid line FIG. 1) where the latent image on the photosensitive drum 1 is developed and a retracting position (not shown) which is separated from the photosensitive drum 1. Accordingly, when the developing section 5 moves to the retracting position so as to be positioned thereto, the supply of a new liquid developing agent to the photosensitive drum 1 is stopped in the meantime.

The first squeeze section 6 is disposed at the downstream of the developing position in the rotation direction D1 of the photosensitive drum 1, and further the second squeeze section 7 is disposed at the downstream side of the first squeeze section 6. In the embodiment, a squeeze roller 61 of the first squeeze section 6 and a squeeze roller 71 of the second squeeze section 7 are both arranged at the left side of the virtual vertical line VL of the drawing paper of FIG. 1 and above the virtual horizontal line HL in the vertical direction.

The first squeeze section 6 is provided with the squeeze roller 61 which is biased toward the photosensitive drum 1 by a spring (not shown). Then, the squeeze roller 61 is rotationally driven by a motor (not shown) while coming into contact with the surface of the photosensitive drum 1 at the first squeeze position so that the excessive developing agent of the toner image is removed. Further, in the embodiment, in order to improve the squeezing efficiency, a first squeeze bias generating section (not shown) is electrically connected to the squeeze roller 61, and a first squeeze bias is applied thereto at an appropriate timing. Further, a cleaning blade 62 comes into contact with the surface of the squeeze roller 61 so that the liquid developing agent adhering to the surface of the roller is scraped out. Then, the liquid developing agent which is scraped out in this way is collected by a collection member 63.

Further, in the second squeeze section 7, the squeeze roller 71 rotates while coming into contact with the surface of the photosensitive drum 1 at a second squeeze position on the downstream side of the first squeeze position in the rotation direction D1 of the photosensitive drum 1 so that the excessive carrier liquid or the fogged toner of the toner image is removed. Further, in the embodiment, in order to improve the squeezing efficiency, as in the first squeeze section 6, a second squeeze bias generating section (not shown) is electrically connected to the squeeze roller 71, and a second squeeze bias is applied thereto at an appropriate timing. Further, a cleaning blade 72 comes into contact with the surface of the squeeze roller 71 so that the liquid developing agent adhering to the surface of the roller is scraped out. Then, the liquid developing agent which is scraped out in this way is guided by the guide member 73 in the direction separated from the photosensitive drum 1, and is collected in a collection member 74 disposed below the guide member 73 in the vertical direction.

Furthermore, in the embodiment, two squeeze sections 6 and 7 are provided, but the number or the arrangement of the squeeze sections is not limited thereto. For example, one squeeze section may be disposed.

A toner image which corresponds to the image signal transmitted to the outside of the apparatus is formed on the photosensitive drum 1 passing through the first and second squeeze sections 6 and 7, and the toner image is transferred to the blanket roller 21 at a primary transfer position TR1. The transfer section 2 which includes the blanket roller 21 is disposed at the left side of the virtual vertical line VL of the drawing paper of FIG. 1 and below the virtual horizontal line HL in the vertical direction. The transfer section 2 includes: the blanket roller 21, a carrier coating mechanism 22 which coats the carrier liquid on the blanket roller 21; a cleaning mechanism 23 of the blanket roller 21; a secondary transfer roller 24; and a cleaning mechanism 25 of the secondary transfer roller 24.

The surface of the blanket roller 21 comes into contact with the surface of the photosensitive drum 1 at the upstream side of the rotation direction D1 of the photosensitive drum 1 in relation to the lowermost position BP of the photosensitive drum 1 in the vertical direction so as to form a primary transfer nip therebetween. The position where the primary transfer nip is formed corresponds to the primary transfer position TR1. Further, the blanket roller 21 is connected to a motor (not shown), and is rotationally driven in the clockwise direction D21 of the drawing paper of FIG. 1 so as to rotate in the complementary direction with respect to the photosensitive drum 1. In this way, the toner image which is carried on the photosensitive drum 1 is firstly transferred to the blanket roller 21 at the primary transfer position TR1.

Further, the secondary transfer roller 24 comes into contact with the blanket roller 21 so as to rotate in the complementary direction at the downstream of the primary transfer position TR1 in the rotation direction D21 of the blanket roller 21 so that a secondary transfer nip is formed therebetween. The position where the secondary transfer nip is formed corresponds to a secondary transfer position TR2. Accordingly, transfer paper is fed to the secondary transfer position TR2 by a conveying section (not shown) and passes through the secondary transfer nip, so that the toner image which is transferred to the blanket roller 21 is secondly transferred to the transfer paper. In this way, the image using the above-described liquid developing agent is printed on the transfer paper.

Further, the carrier coating mechanism 22 is disposed at the downstream side of the secondary transfer position TR2 in the rotation direction D21 of the blanket roller 21 so that the carrier liquid is coated on the surface of the blanket roller 21 after the secondary transfer process. In order to perform the carrier liquid coating process, the carrier coating mechanism 22 includes: a carrier coating roller 221 which rotates in the complementary direction with respect to the blanket roller 21; a carrier storing member 222 which stores the carrier liquid; and a carrier pumping roller 223 which supplies the carrier liquid to the carrier coating roller 221 by pumping the carrier liquid up from the carrier storing member 222.

The cleaning mechanism 23 is disposed at the downstream side of the carrier coating mechanism 22 and the upstream side of the primary transfer position TR1 in the rotation direction D21 of the blanket roller 21 so that the surface of the blanket roller 21 immediately before the primary transfer process is cleaned. In order to perform the cleaning process, the cleaning mechanism 23 includes: a cleaning roller 231 which rotates in the counter direction with respect to the blanket roller 21; a cleaning blade 232 which cleans the cleaning roller 231 while coming into contact with the cleaning roller 231; and a collection member 233 which collects the toner or the carrier liquid scraped out by the cleaning blade 232.

The cleaning mechanism 25 is disposed at the upstream side of the secondary transfer position TR2 in the rotation direction of the secondary transfer roller 24 so that the surface of the secondary transfer roller 24 before the secondary transfer process is cleaned. In order to perform the cleaning process, the cleaning mechanism 25 includes: a cleaning blade 251 which cleans the secondary transfer roller 24 while coming into contact with the secondary transfer roller 24 and a collection member 252 which collects the toner or the carrier liquid scraped out from the cleaning blade 251.

The photoreceptor cleaning section 8 is disposed at the downstream of the primary transfer position TR1 and the upstream side of the charging position in the rotation direction D1 of the photosensitive drum 1. The photoreceptor cleaning section 8 includes: a cleaning blade 81; a developing agent receiving member 82 which receives the liquid developing agent drooping from the lowermost position BP of the photosensitive drum 1; a collection member 83 which collects the developing agent received in the developing agent receiving member; and a support member 84 which integrally supports the cleaning blade 81, the developing agent receiving member 82, and the collection member 83. Then, the support member 84 is configured to be rotatable about the rotary shaft 85 serving as the rotation center.

Further, a spring member (not shown) is connected to the support member 84 so as to bias the support member 84 in the counter-clockwise direction of the drawing paper of FIG. 1, and this force acts in the direction in which the cleaning blade 81 is separated from the photosensitive drum 1. On the other hand, an engagement portion 841 protrudes from the end portion of the support member 84 at the opposite photosensitive drum side (the right side of FIG. 1). When a movable piece (not shown) presses the engagement portion 841 due to the stress larger than the biasing force, the support member 84 rotates in the clockwise direction of the drawing paper of FIG. 1. Thus, the cleaning blade 81 moves toward the photosensitive drum, so that the front end portion of the cleaning blade 81 comes into contact with a position (hereinafter referred to as a “lowermost position”) BP which intersects with the virtual perpendicular plane VP below the photosensitive drum 1 in the vertical direction. Thus, the liquid developing agent which remains on the photosensitive drum 1 is cleaned and removed. Furthermore, the liquid developing agent which is scraped out by the cleaning blade 81 in this way is received by the developing agent receiving member 82 which is disposed below the lowermost position BP of the photosensitive drum 1 in the vertical direction, and further flows and falls into the collection member 83 along the inclined surface of the developing agent receiving member 82 so as to be stored therein.

Next, the configuration and the effect of the charger air flow duct 32 will be described by referring to FIGS. 1 to 3. The charger air flow duct 32 includes a duct main body 323, and as shown in FIG. 1, in the inside of the duct main body 323, the external air introduction path 321 and the exhaust path 322 are stacked in the vertical direction, and a partition member 324 is disposed between the path. Further, the end portion of the duct main body 323 at the side of the charger 31 is largely opened. Further, an upper end seal 325 is provided at the upper end portion of the opening so as to extend from the duct main body 323 toward the charger 31 positioned at the uppermost portion, and the front end portion of the seal 325 comes into contact with the upper surface of the charger 31 of the uppermost portion. On the other hand, a lower end seal 325 is provided even at the lower end portion of the opening so as to extend from the duct main body 323 toward the charger 31 positioned at the lowermost portion. The front end portion of the seal 325 comes into contact with the lower surface of the charger 31 of the lowermost portion. In this way, the ambient atmosphere of the charger 31 is separated from the exposure section 4 and the photoreceptor cleaning section 8 disposed around the charging section 3. Then, the external air introduction path 321 communicates with the opening and guides the air received from the outside of the apparatus so as to be sprayed out toward the ambient atmosphere. Further, the exhaust path 322 is also connected to the opening, so that the ambient atmosphere may be ventilated. For this reason, ozone or the like which is generated by the discharging process of the charger 31 may be discharged to the outside of the apparatus. In this way, the charger air flow duct 32 serves to ventilate the ambient atmosphere of the charger 31. Furthermore, the shape of the charger air flow duct 32, the layer structure thereof, the presence of the upper end seal, or the direction of the supplied or discharged air flow is an example, and the configuration of this specification is not limited thereto.

Further, an upper surface 326 of the duct main body 323 is provided so that the lowermost end portion 5b of the developing section 5 is directed upward in the vertical direction, and in the upper surface 326, a fence 327 is formed upright along the entire circumference so as to form a collection space of the liquid developing agent. In the embodiment, as shown in FIG. 2, the fence gap of the photosensitive drum 1 in the rotation axis direction X, that is, the width W32 of the upper surface 326 is set to be longer than the width W31 of the charger 31 and the width W5 of the developing section 5. More specifically, the following equation is satisfied.

W31<W5<W32

For this reason, the lowermost end portion 5b of the developing section 5 is inserted into the collection space (the space where the upper surface 326 is surrounded by the fence 327). Further, a joint member 91 which is fixed to the bottom surface of the developing agent container 54 of the developing section 5 is also positioned above the collection space in the vertical direction. Accordingly, even when the liquid developing agent leaks and drops from the developing section 5 due to the developing process, the liquid developing agent is collected in the collection space. Further, in order to perform the replacement or the like of the developing section 5, there is a need to eliminate a pipe extending from the joint member 91 if necessary. Then, at this time, there is a possibility that the liquid developing agent may leak. However, as described above, since the collection space is present below the joint member 91 in the vertical direction, the leaking liquid developing agent may be reliably collected. Accordingly, the liquid developing agent which leaks and drops from the developing section 5 while reliably ventilating the entire ambient atmosphere of the charger 31 may be received in the upper surface 326 of the duct main body 323. Furthermore, since the fence 327 is formed upright along the entire periphery of the upper surface 326, the liquid developing agent which is received by the upper surface 326, that is, the waste liquid is prevented from overflowing from the upper surface 326. Accordingly, the waste liquid may be reliably stored in the collection space. Furthermore, since the charger air flow duct 32 is used at the time of collecting the waste liquid, there is no need to provide an independent component which prevents the leakage of the liquid developing agent from the developing section 5. As a result, it is possible to reliably prevent the inside of the apparatus from being contaminated by the liquid developing agent while saving space and reducing cost.

In this way, in the first embodiment, the photosensitive drum 1 corresponds to the “latent image carrying drum” of the invention. Further, the developing agent container 54 corresponds to the “container which stores the liquid developing agent” of the invention. Further, the fence 327 corresponds to the “wall portion” of the invention. However, the method of forming the fence 327 is not particularly limited. The fence 327 may be bonded to the upper surface 326 of the duct main body 323 by welding or the like or may be integrally formed with the duct main body 323.

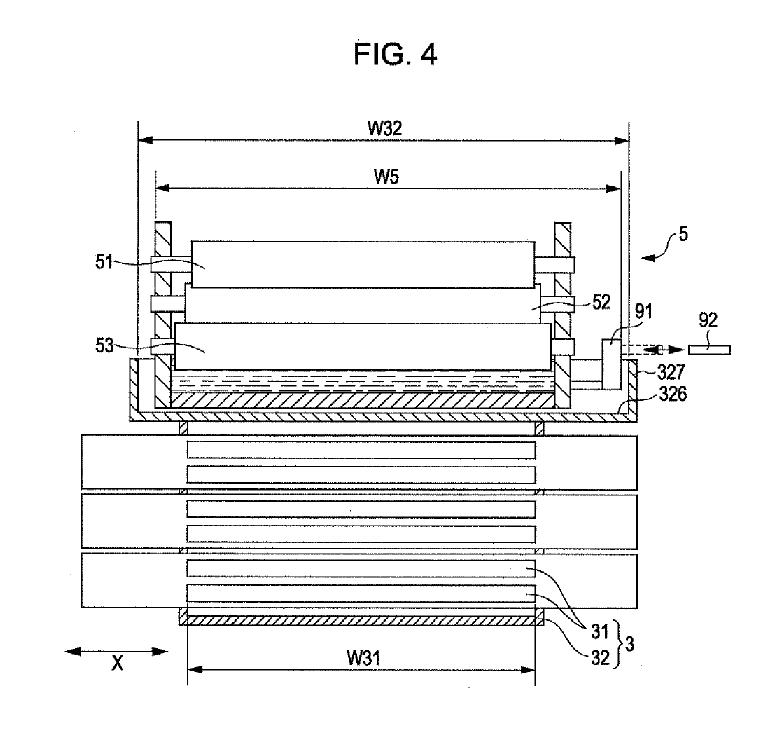

FIG. 4 is a diagram illustrating a second embodiment of the image forming apparatus according to the invention. The major difference between the second embodiment and the first embodiment is that the fixing position of the joint member 91 is different and the size of the upper surface 326 of the duct main body 323 is different in accordance with the different fixing position. The other configurations are basically the same as those of the first embodiment. Accordingly, in the description below, the differences will be mainly described, and the description of the same configuration will be omitted by giving the same reference numerals to the same components.

In the first embodiment, the joint member 91 is fixed to the bottom surface of the developing agent container 54 of the developing section 5. However, in the second embodiment, as shown in FIG. 4, the joint member 91 is provided in one side surface of the developing agent container (the right side surface of the same drawing) in the rotation axis direction X. In this way, since the pipe 92 which allows the liquid developing agent from the rotation axis direction X may be inserted into or extracted from the joint member 91, it is possible to easily perform the replacement or the like of the developing section 5 and improve the maintenance workability.

Then, in the second embodiment, the upper surface 326 of the duct main body 323 extends in the rotation axis direction X so as to correspond to the configuration in which the joint member 91 is disposed at the side surface of the developing section 5 in the rotation axis direction X. That is, the upper surface 326 of the duct main body 323 is longer than the distance W5 from the joint member 91 to the other side surface of the developing section 5 in the rotation axis direction X, and a collection space which is surrounded by the upper surface 326 and the fence 327 is also present below the joint member 91 in the vertical direction. Accordingly, the liquid developing agent which leaks and drops from the lowermost end portion 5b of the developing section 5 as well as the liquid developing agent which leaks when the pipe 92 is inserted to and extracted from the joint member 91 may be reliably collected. As a result, as in the first embodiment, it is possible to reliably prevent the inside of the apparatus from being contaminated by the liquid developing agent while saving space and reducing cost.

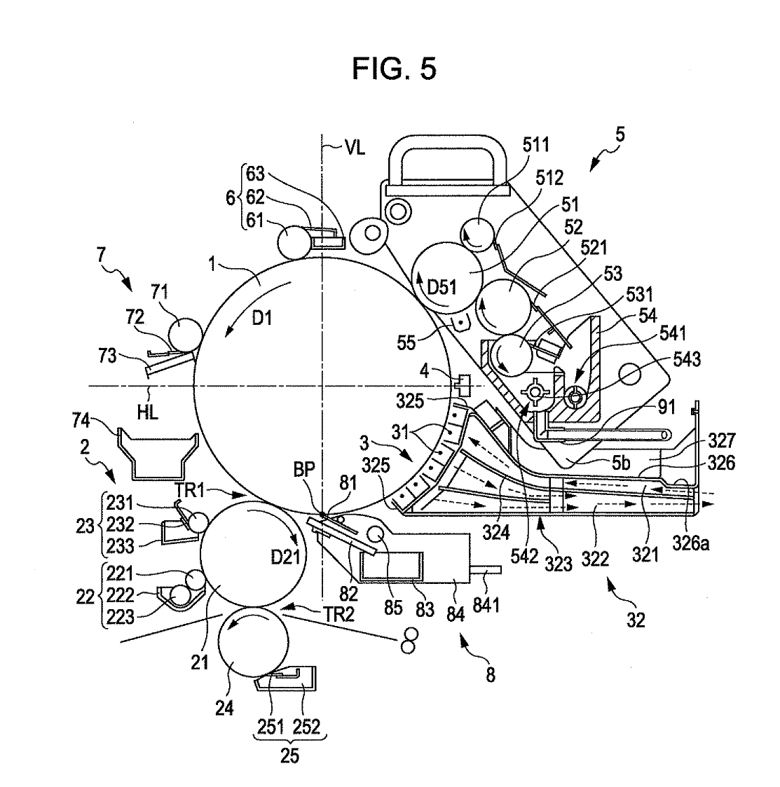

FIG. 5 is a diagram illustrating a third embodiment of the image forming apparatus according to the invention. The major difference between the third embodiment and the first embodiment is that the structure of the upper surface is different. The other configurations are basically the same as those of the first embodiment. Accordingly, in the description below, the differences will be mainly described, and the description of the same configuration will be omitted by giving the same reference numerals to the same components.

In the third embodiment, the upper surface 326 of the duct main body 323 is formed as an inclined surface which continuously descends as it moves away from the charger 31, and a step portion is formed at the end portion of the opposite side of the charger 31 (the right side of the drawing) and serves as a liquid storage portion 326a of the liquid developing agent. For this reason, the liquid developing agent which leaks from the developing section 5 and is received in the upper surface 326, that is, the waste liquid flows along the upper surface 326 and is stored in the liquid storage portion 326a. In this way, according to the embodiment, the leaking liquid developing agent may be easily collected.

Furthermore, in the third embodiment, the upper surface 326 of the duct main body 323 is finished as an inclined surface which continuously descends, but may be finished so as to be inclined in a step shape.

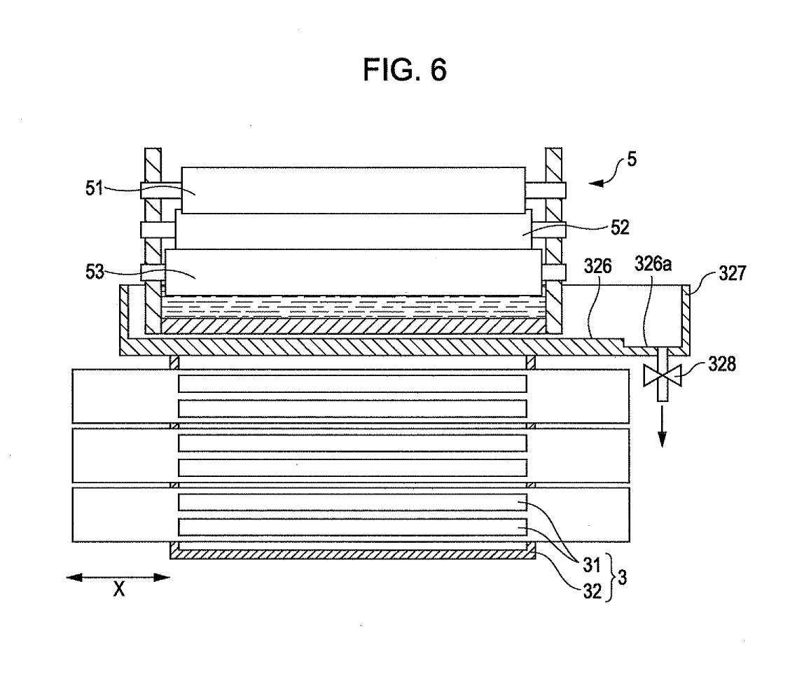

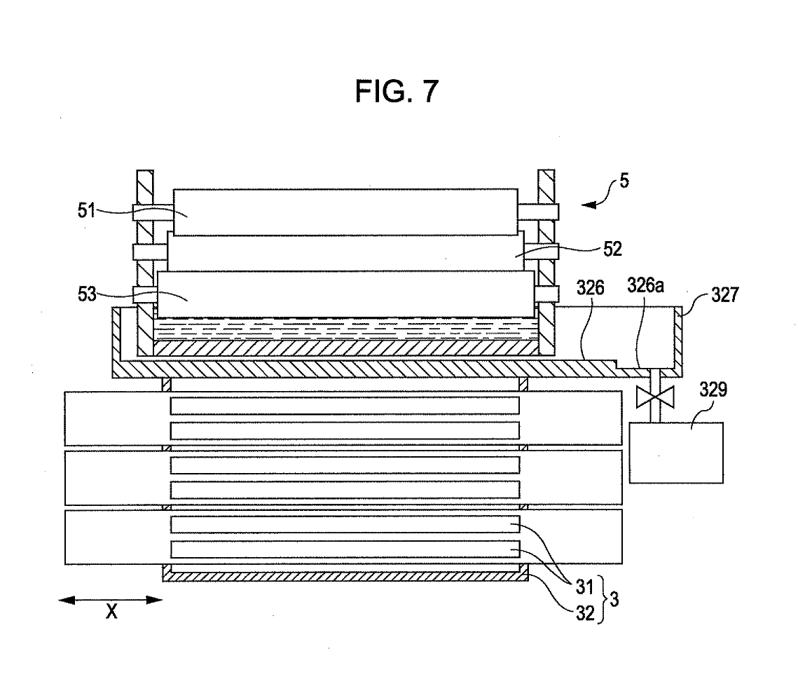

Further, as described above, in order to separate (collect and dispose) the waste liquid which is stored in the liquid storage portion 326a from the image forming apparatus, for example, as shown in FIG. 6, a discharge drain 328 may be installed in the bottom surface of the liquid storage portion 326a (a fourth embodiment). Further, for example, as shown in FIG. 7, a waste liquid collection container 329 may be installed in the bottom surface of the liquid storage portion 326a in a removable manner (a fifth embodiment). Furthermore, in a case where the discharge drain 328 or the waste liquid collection container 329 is installed in this way, it is desirable that the installation position thereof be the opposite side of the photosensitive drum 1 and the end portion of the rotation axis direction X as shown in FIG. 6 or 7. When the discharge drain 328 or the waste liquid collection container 329 is installed at the corresponding position, it is possible to prevent the waste liquid from flowing into the charger 31.

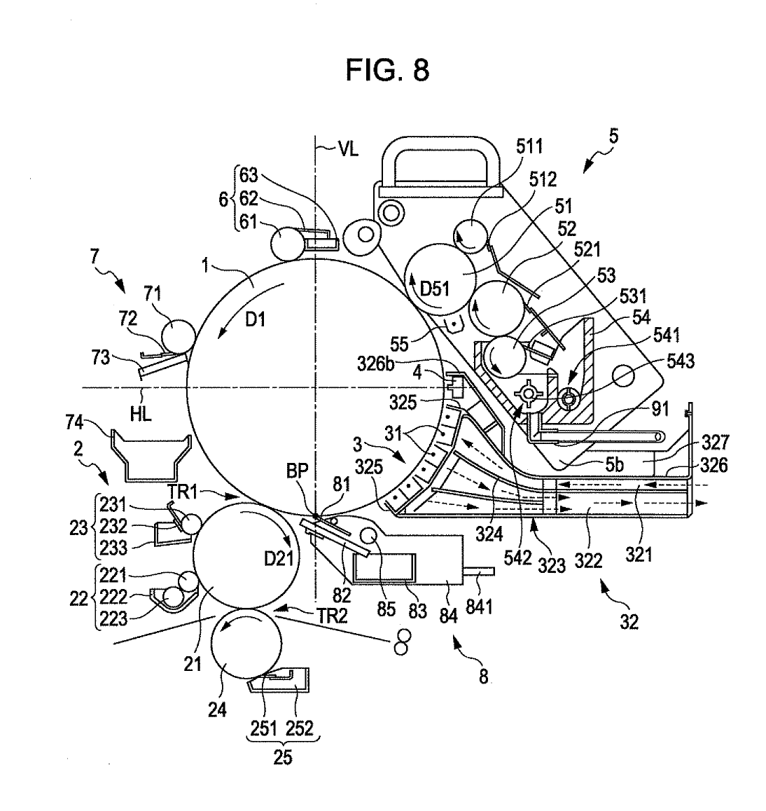

FIG. 8 is a diagram illustrating a sixth embodiment of the image forming apparatus according to the invention. The major difference between the sixth embodiment and the first embodiment is that the upper surface 326 of the duct main body 323 extends between the exposure section 4 and the developing section 5 so as to cover the upside of the exposure section 4 in the vertical direction. The other configurations are basically the same as those of the first embodiment. In this way, the upper surface 326 extends to the exposure section 4, and the extension portion is present as the cover member 326b. Accordingly, for example, even when the liquid developing agent which leaks from the developing section 5 above the exposure section 4 in the vertical direction drops from the developing roller 51, the liquid developing agent is received by the cover member 326b disposed in the charger air flow duct 32, thereby preventing the liquid developing agent from intruding into the exposure section 4 and satisfactorily performing the exposure process.

As described above, the wall portion may be disposed above the air flow duct in the vertical direction.

Further, the developing section includes the container which stores the liquid developing agent, the pipe which makes the liquid developing agent flow in the container, and the joint member which is disposed at one side of the developing section in the rotation axis direction of the latent image carrying drum so as to be used to attach and detach the pipe, wherein the air flow duct may be formed so as to be longer than the distance from the joint member to the other side opposite to the one side of the developing section in the rotation axis direction of the latent image carrying drum.

Further, the air flow duct may be formed so as to be inclined in a continuous or step shape.

Further, the air flow duct may be inclined downward in the vertical direction so as to be separated from the corona charger, the liquid storage portion of the liquid developing agent may be disposed at the opposite end portion of the corona charger, and the discharge drain may be connected to the liquid storage portion.

Further, the collection container may be disposed so as to collect the liquid developing agent while being connected to the discharge drain.

Furthermore, the exposure section which forms the latent image on the latent image carrying drum may be disposed between the charging section and the developing section, and the cover member may be disposed in the air flow duct so as to cover the upside of the exposure section in the vertical direction.

Furthermore, the invention is not limited to the above-described embodiments, and may be modified into various forms without departing from the spirit of the invention. For example in the above-described embodiments, a case has been described in which the invention is applied to an image forming apparatus with a so-called lower transfer structure. However, the invention may be applied to an image forming apparatus with a so-called upper transfer structure which is disposed above the virtual horizontal plane HP passing through the rotation center of the photosensitive drum 1 in the vertical direction so as to transfer an image carried on the photosensitive drum 1. Further, the application subject of the invention is not limited to the image forming apparatus, and the invention may be also applied to the image carrying section that includes the photosensitive drum 1, the charger 31, the charger air flow duct 32, and the developing section 5.

Further, in the above-described embodiments, the blanket roller 21 is used as the intermediate transfer medium, but instead of the roller, for example, a belt-like intermediate transfer body may be used.

Next, the third and fourth aspects of the invention will be described. Hitherto, a liquid developing type image forming apparatus has been practically used, in which an electrostatic latent image is formed on a charged photoreceptor and a toner image is formed by developing the electrostatic latent image using a liquid developing agent obtained by dispersing toner in a carrier liquid. For example, in an image forming apparatus disclosed in JP-A-2009-175425 (FIG. 1), a developing unit which includes a charging member (corresponding to the “charging member” of the invention) is used. The charging member is disposed so as to face a developing roller and gives a charge to the liquid developing agent coated on the developing roller. Then, the charging member and the developing roller are integrally connected to each other by two side plates so as to move together, whereby the relative positional relationship therebetween is maintained to be constant.

However, in the existing developing unit, since the liquid developing agent including a carrier liquid and toner is used, a problem may arise in which the liquid developing agent adhering to the surface of the developing roller moves on the surface of the developing roller and droops when the developing process is stopped or the maintenance is performed. Accordingly, the liquid developing agent which droops and drops from the developing roller adheres to the charging member, and hence the charging member is contaminated, which is a factor that induces irregularity of an image. Accordingly, it is important to prevent the contamination of the charging member. However, there is no sufficient examination how the charging member is positioned when the developing roller is positioned, and the above-described problem arises.

An advantage of some aspects of the invention is that it provides a technique capable of preventing the charging member from being contaminated by the liquid developing agent in the developing unit that performs a developing process using the liquid developing agent charged by the charging member and the image forming apparatus equipped with the developing unit.

According to the third aspect of the invention, there is provided a developing unit including: developing equipment that includes a developing agent carrying roller carrying a liquid developing agent including toner and a carrier liquid and a charging member disposed below the virtual horizontal plane perpendicular to the virtual perpendicular plane passing through the rotation center of the developing agent carrying roller in the vertical direction so as to charge the liquid developing agent carried on the developing agent carrying roller; and a developing equipment supporting section that supports the developing equipment at a first position and a second position different from the first position and supports the developing equipment in a posture in which the charging member does not intersect with the virtual perpendicular plane when the developing equipment is supported at the first position and the second position.

Further, according to the fourth aspect of the invention, there is provided an image forming apparatus including: a latent image carrier on which a latent image is formed; an exposure section that forms the latent image by exposing a latent image carrier; a developing section that includes a developing agent carrying roller carrying a liquid developing agent including toner and a carrier liquid, a charging member which is disposed below the virtual horizontal plane perpendicular to the virtual perpendicular plane passing through the rotation center of the developing agent carrying roller in the vertical direction so as to charge the liquid developing agent carried on the developing agent carrying roller, and a support member supporting the developing agent carrying roller and the charging member and that develops the latent image; and a developing equipment supporting section that supports the developing equipment at a first position and a second position different from the first position and supports the developing equipment in a posture in which the charging member does not intersect with the virtual perpendicular plane when the developing equipment is supported at the first position and the second position.

In this way, in the developing unit and the image forming apparatus, the developing equipment supporting section supports the developing equipment at the first position and the second position. However, in any position, a posture is taken in which the charging member does not intersect with the virtual perpendicular plane. For this reason, it is possible to prevent a problem in which the liquid developing agent droops from the developing agent carrying roller and adheres to the charging member, so that the charging member is contaminated.

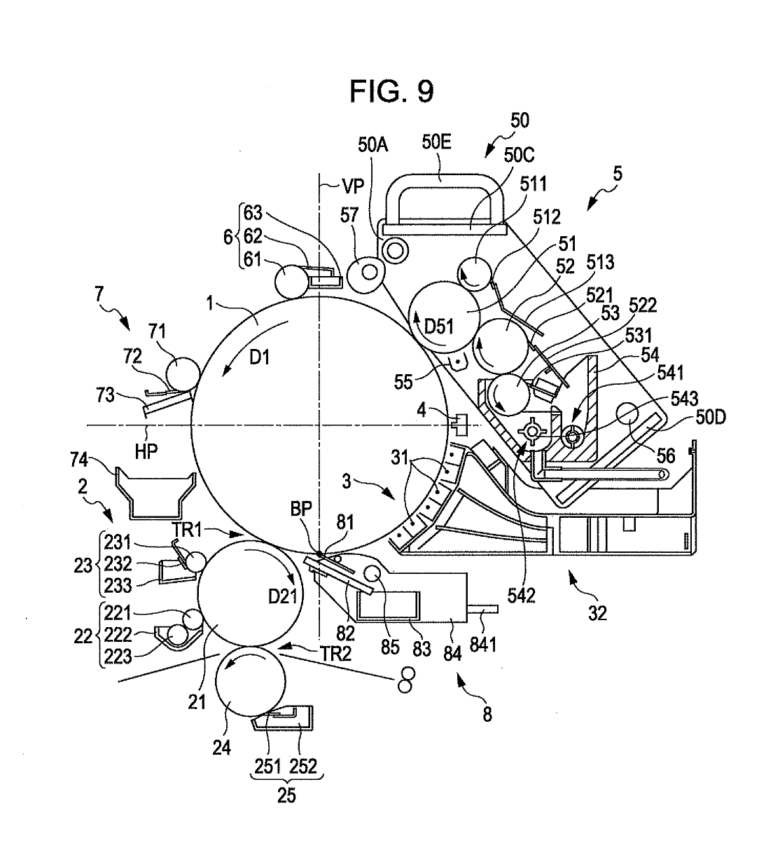

FIG. 9 is a diagram illustrating a seventh embodiment of the image forming apparatus according to the invention. Furthermore, the image forming apparatus is the same as the first embodiment of the image forming apparatus according to the invention shown in FIG. 1. The description of the same component will be omitted by giving the same reference numerals of FIG. 1 thereto and the differences will be mainly described below.

Next, the configuration and the effect of the developing section 5 will be described by referring to FIGS. 9 to 16C. The developing section 5 includes the developing equipment which develops the latent image carried on the photosensitive drum 1 and the developing equipment supporting section which supports the developing equipment at the developing position, the separation position, and the maintenance position. Furthermore, here, the configuration of respective components of the developing section 5 when the respective components are positioned at a position where the developing process is performed will be described, and the positioning operation of the developing equipment during the developing process, the separation process, and the maintenance process will be described.

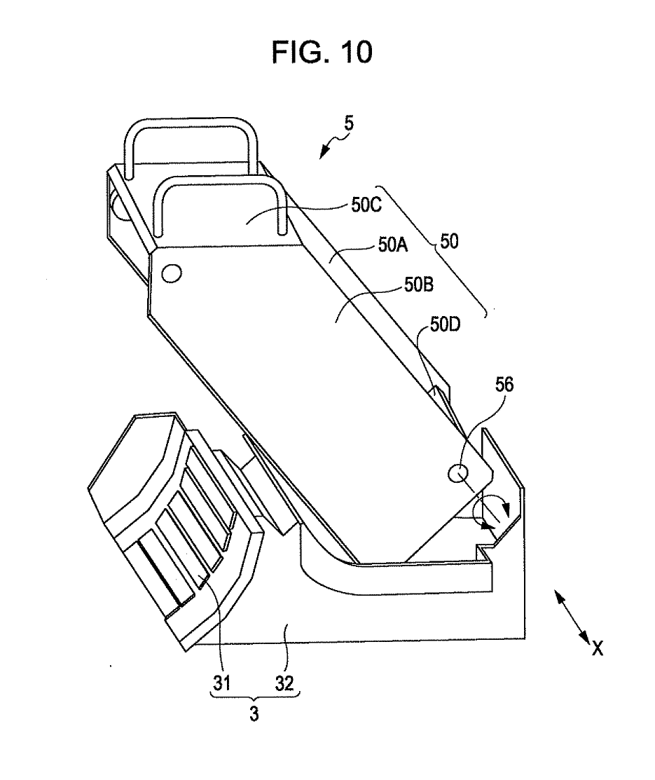

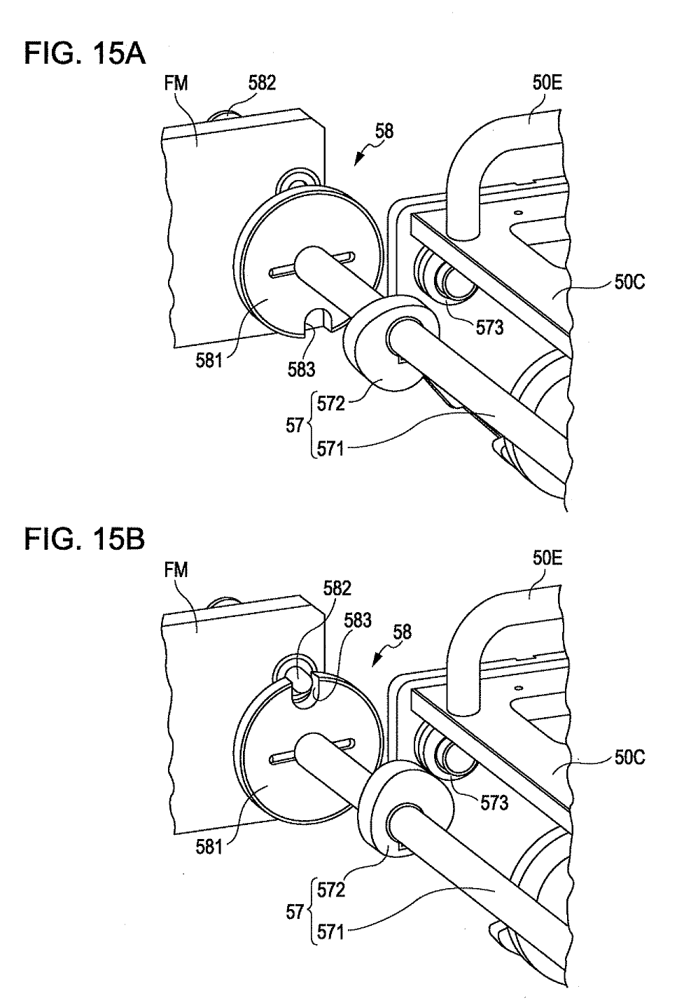

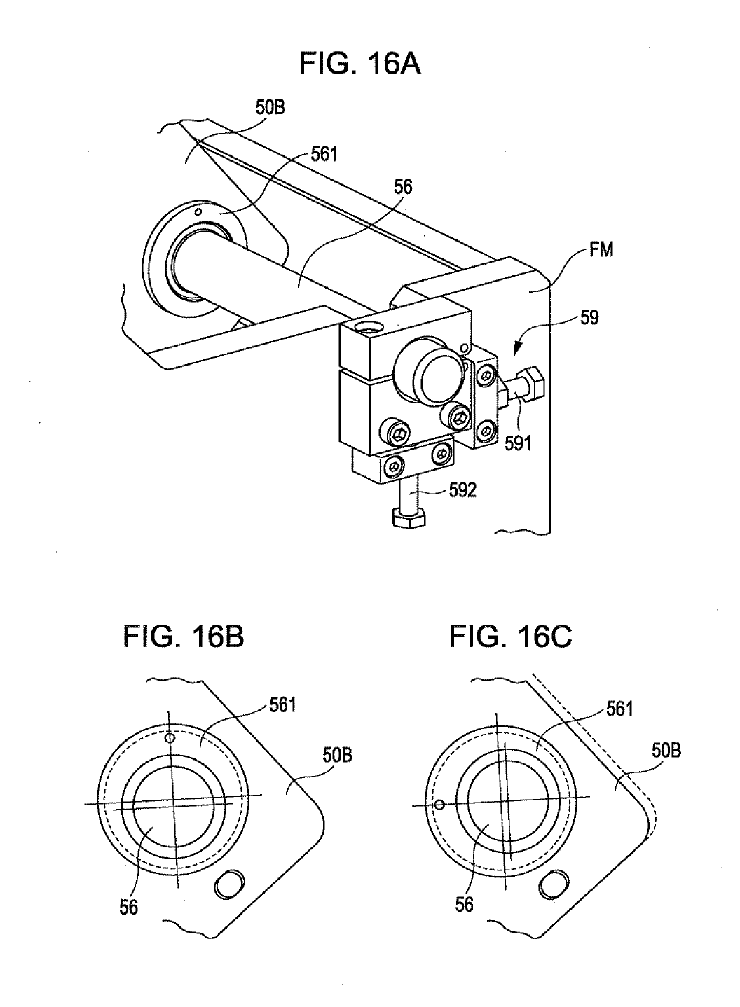

FIG. 10 is a perspective view illustrating the arrangement relationship between the charging section and the developing section. In the developing section 5, as shown in the same drawing, a developing equipment supporting section 50 includes: two side plates 50A and 50B which are separated from each other in the rotation axis direction X; an upper connection member 50C which connects the upper end portions of the side plates 50A and 50B to each other; and a lower connection member 50D which connects the lower end portions of the side plates 50A and 50B to each other. Then, the main components constituting the developing equipment are attached to the developing equipment supporting section 50. That is, the main components correspond to the developing roller 51, the intermediate coating roller 52, the anilox roller 53, the developing agent container 54, and the toner compressing corona generator 55. Then, the developing equipment is configured to be rotatable about the rotary shaft 56 serving as the rotation center to be described later relative to the apparatus main body frame FM of the image forming apparatus (see FIGS. 15A to 16C) at the right side of the virtual perpendicular plane VP passing through the rotation center of the photosensitive drum 1 of the drawing paper of FIG. 9.

The developing section 5 of the image forming apparatus has a so-called three-roller structure with the developing roller 51, the intermediate coating roller 52, and the anilox roller 53. In these rollers 51 to 53, all rotary shafts are arranged so as to be parallel to the rotary shaft of the photosensitive drum 1 and both end portions thereof are axially supported to the side plates 50A and 505 so as to be rotatable.

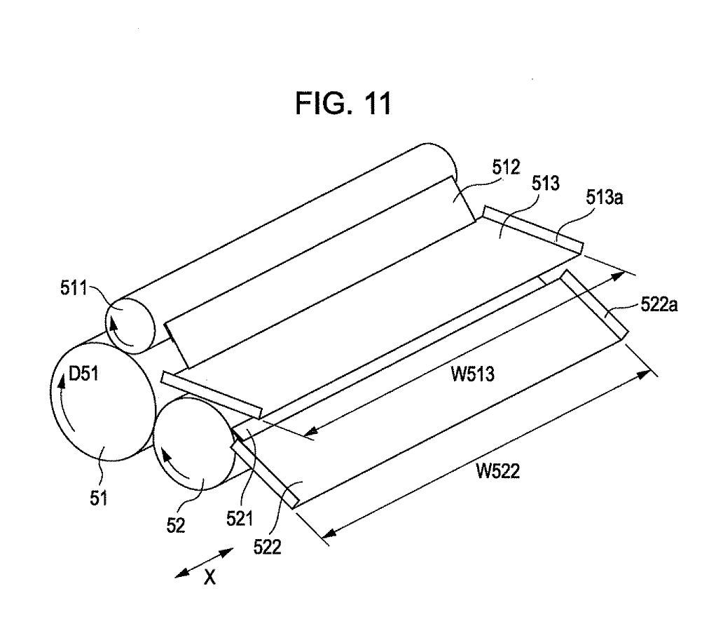

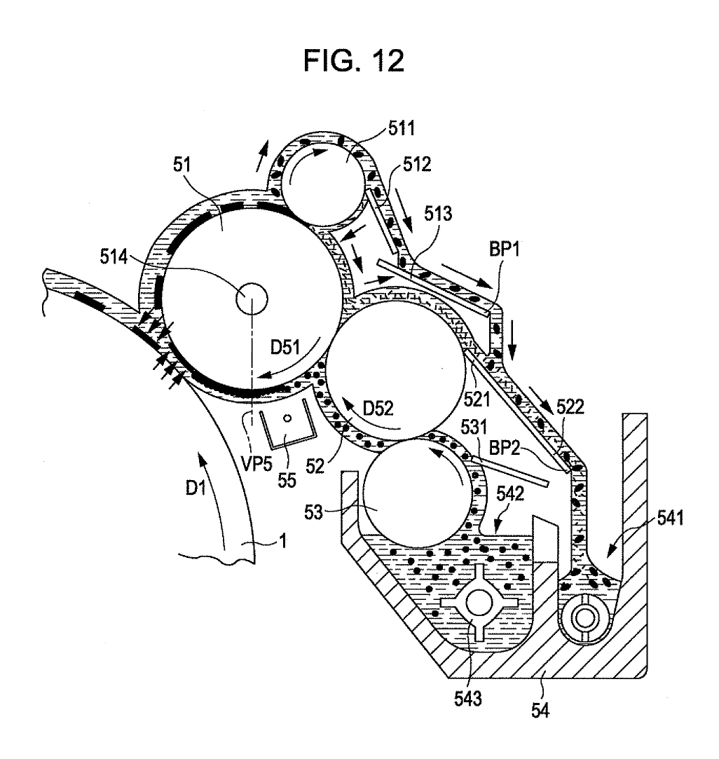

FIG. 11 is a perspective view illustrating the outline configuration of the cleaning mechanism of the developing roller and the intermediate coating roller. Further, FIG. 12 is a schematic diagram illustrating the collection path of the waste liquid which is collected by the cleaning mechanism. As shown in FIGS. 9, 11, and 12, the cleaning roller 511 comes into contact with the developing roller 51, and the roller cleaning blade 512 comes into contact with the cleaning roller 511, thereby performing the cleaning process of the developing roller 51. That is, the cleaning roller 511 rotates in the clockwise direction of the drawing paper of FIGS. 11 and 12 while coming into contact with the surface of the developing roller 51 at the downstream side of the developing roller rotation direction D51 in relation to the developing position where the surface of the developing roller 51 comes into contact with the photosensitive drum 1 so as to form a developing nip therebetween. Accordingly, the cleaning roller 511 rotates in the counter direction with respect to the developing roller 51 and removes the liquid developing agent which does not contribute to the developing process and remains on the developing roller 51. Further, the roller cleaning blade 512 comes into contact with the surface of the cleaning roller 511 so that the liquid developing agent is scraped out and dropped to be removed therefrom. Furthermore, an inclined member 513 is disposed below the roller cleaning blade 512. With regard to the inclined member 513, the end portion on the side of the developing roller (the left side of FIG. 9) is set to be higher than the end portion on the side of the opposite side of the developing roller (the right side of FIG. 9) in the vertical direction, and the inclined member is inclined downward as it moves away from the developing roller 51. Then, the inclined member 513 is fixed to the developing equipment supporting section 50 so that the end portion on the side of the developing roller is positioned below the roller cleaning blade 512 in the vertical direction. For this reason, the liquid developing agent (the waste liquid) which is scraped out and dropped by the blade 512 is received in the inclined member 513 and is guided to the opposite side of the developing roller. Furthermore, fences 513a which extend upward are respectively formed at both end portions of the inclined member 513 in the rotation axis direction X, thereby preventing the waste liquid from overflowing from both end portions of the inclined member 513 and reliably collecting the waste liquid.

Further, the cleaning blade 521 comes into contact with the intermediate coating roller 52, so that the liquid developing agent which does not contribute to the developing process and remains on the intermediate coating roller 52 is scraped out and dropped from the surface of the intermediate coating roller 52. The end portion of the cleaning blade 521 on the opposite side of the intermediate coating roller (the right side of FIG. 9) is connected to an inclined member 522. With regard to the inclined member 522, the end portion on the side of the intermediate coating roller (the left side of FIG. 9) is set to be higher than the end portion on the opposite side of the intermediate coating roller (the right side of FIG. 9) in the vertical direction, and the inclined member is inclined downward at it moves away from the intermediate coating roller 52. Then, the inclined member 522 is fixed to the developing equipment supporting section 50 so that the end portion on the side of the intermediate coating roller is positioned below the end portion of the inclined member 513 on the opposite side of the developing roller in the vertical direction and the end portion on the opposite side of the intermediate coating roller is positioned above the collection portion 541 of the developing agent container 54 in the vertical direction. Furthermore, in the rotation axis direction X, the end portion of the inclined member 522 on the side of the intermediate coating roller is set to be longer than the end portion of the inclined member 513 on the opposite side of the developing roller. That is, in the rotation axis direction X, the length W513 of the end portion of the inclined member 513 on the opposite side of the developing roller and the length W522 of the inclined member 522 on the side of the intermediate coating roller satisfy the following relationship.

W513<W522

For this reason, as shown in FIG. 12, the liquid developing agent (the waste liquid) which is scraped out and dropped by the blade 521 is guided along the inclined member 522 toward the opposite side of the intermediate coating roller, and the waste liquid which is guided and dropped by the inclined member 513 (the liquid developing agent which is cleaned and removed from the developing roller 51) is received in the end portion of the inclined member 522 on the side of the intermediate coating roller and is guided to the opposite side of the intermediate coating roller. Then, the liquid developing agent (the waste liquid) which is scraped out by the blades 512 and 521 also flows from the inclined member 522 to the collection portion 541 of the developing agent container 54 so as to be collected therein. Furthermore, as in the inclined member 513, even in the inclined member 522, both end portions of the inclined member 522 in the rotation axis direction X are respectively provided with fences 522a extending upward, thereby preventing the waste liquid from overflowing from both end portions of the inclined member 522 and reliably collecting the waste liquid.

Further, the toner compressing corona generator 55 is disposed at the upstream side of the developing position in the rotation direction D51 of the developing roller 51, and is fixed to the developing equipment supporting section 50. More specifically, in the drawing paper of FIG. 12, the toner compressing corona generator 55 is disposed at the right side of the virtual perpendicular plane VP5 extending downward in the vertical direction from a rotary shaft 514 of the developing roller 51 and below the virtual horizontal plane (not shown) passing through the rotary shaft 514 in the vertical direction. The toner compressing corona generator 55 is an electric field applying section which increases the bias of the surface of the developing roller 51. The electric field is applied to a position where the toner of the liquid developing agent which is conveyed by the developing roller 51 approaches the toner compressing corona generator 55, and the charging and compressing process is performed.

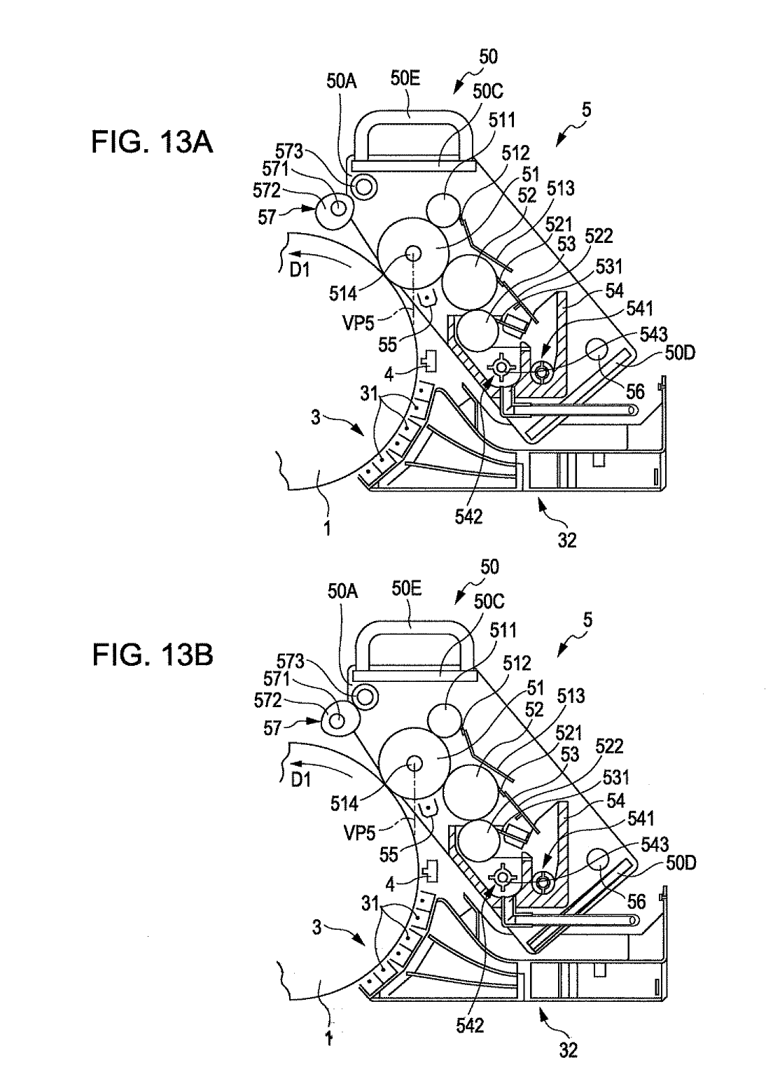

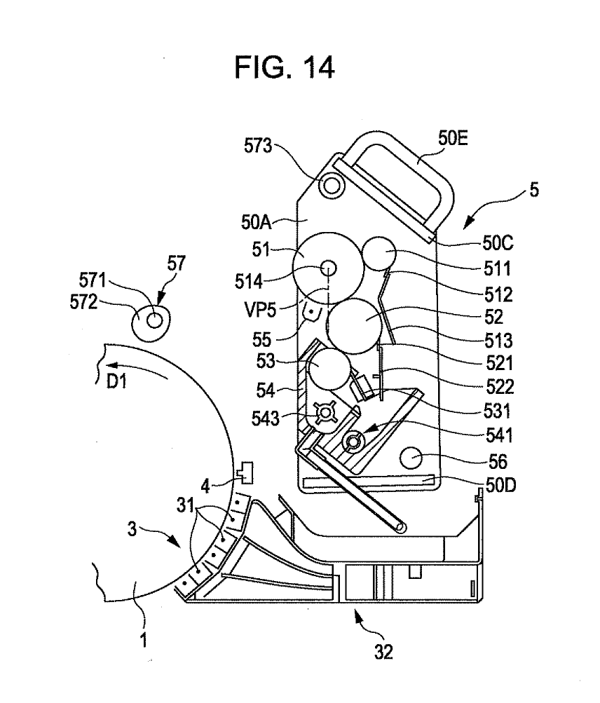

In this way, the main components of the developing equipment are respectively fixed to the developing equipment supporting section 50. Further, one end portion of the rotary shaft 56 is axially supported to the side plate 50A, and the other end portion thereof is axially supported to the side plate 50B. For this reason, the developing equipment is configured to be rotatable about the rotary shaft 56 serving as the rotation center while being supported by the developing equipment supporting section 50. Then, a moving mechanism 57 to be described later moves and positions the developing roller 51 to a contact position (FIG. 13A: a developing position) where the developing roller comes into contact with the photosensitive drum 1 so as to perform the developing process and a separation position (FIG. 13B: a non-developing position) where the developing roller is separated from the contact position so as not to perform the developing process. Further, when the developing roller 51 is positioned at the separation position, a movement regulating mechanism 58 to be described later is activated, so that the movement of the developing roller 51 is regulated. Then, when the regulation of the movement regulating mechanism 58 is released, the movement of the developing roller 51 is permitted. Furthermore, when a user largely rotates the developing equipment supporting section 50 about the rotary shaft 56 serving as the rotation center by operating a handle 50E fixed to the upper surface of the upper connection member 50C, the developing section 5 is largely separated from the photosensitive drum 1 and is positioned at a maintenance position (FIG. 14) where the replacement or the like of the developing section 5 is performed. In this way, in the embodiment, the developing section 5 may be positioned at three different positions.

Next, the configuration and the operation of the moving mechanism 57 and the movement regulating mechanism 58 will be described by referring to FIGS. 13A to 15B. FIGS. 15A and 15B are partially enlarged views illustrating the configuration of the moving mechanism and the movement regulating mechanism. The moving mechanism 57 includes: a rotary shaft 571 which is axially supported to the apparatus main body frame FM so as to be rotatable above the photosensitive drum 1 and a separation and contact cam 572 which is fixed to the rotary shaft 571 so as to rotate along with the rotary shaft 571. On the other hand, the movement regulating mechanism 58 includes: a rotation member 581 which is fixed to the end portion of the rotary shaft 571 so as to rotate together about the rotary shaft 571; a movable member pin 582 which is attached to the apparatus main body frame FM and is movable in a reciprocating manner relative to the rotation member 581; and a solenoid (not shown) which drives the movable member pin 582 in a reciprocating manner. Furthermore, the peripheral edge portion of the rotation member 581 is provided with a substantially U-shaped notch portion 583.

The rotary shaft 571 is connected to a motor (not shown), and is rotationally driven by the rotation of the motor. Then, as shown in FIG. 15A, the developing equipment supporting section 50 rotates in the counter-clockwise direction about the rotary shaft 56 in the drawing paper of FIG. 13A due to the own weight while the separation and contact cam 572 is separated from a cam follower 573 fixed to the inner surface of the side plate 50A, and the developing roller 51 comes into contact with the photosensitive drum 1, thereby performing the developing process. In this way, the developing roller 51 is positioned at the contact position (the developing position). Furthermore, the contact pressure of the developing roller 51 with respect to the photosensitive drum 1 may be adjusted by providing a separate spring member. Further, when the developing roller 51 is positioned at the contact position (the developing position), as shown in FIG. 15A, the notch portion 583 faces downward in the vertical direction.

Then, when the rotary shaft 571 is rotated by 180° by the motor, the separation and contact cam 572 comes into contact with the cam follower 573 in accordance with the rotation, so that the developing equipment supporting section 50 is rotated in the clockwise direction about the rotary shaft 56 in the drawing paper of FIG. 135 and hence the developing roller 51 is separated from the photosensitive drum 1. Here, when the excitation of the motor is released, the rotary shaft 571 rotates, so that the developing roller 51 comes into contact with the photosensitive drum 1. In this way, when the developing roller 51 keeps coming into contact with the photosensitive drum 1 while the developing process is not performed, the surface layer of the developing roller 51, that is, the elastic layer is partially deformed, so that the thickness of the thin layer of the liquid developing agent becomes irregular and hence a satisfactory toner image is not easily formed. Therefore, in the embodiment, as shown in FIG. 15B, the movable member pin 582 is made to advance by the solenoid so that the front end of the pin is inserted into the notch portion 583 which moves to the position of the movable member pin 582 with the rotation of the rotary shaft 571 by 180°, thereby locking the rotation member 581. As a result, the rotation of the rotary shaft 571 is forcibly stopped, and the developing roller 51 is maintained to be separated from the photosensitive drum 1.

Furthermore, when the developing process is performed, the movable member pin 582 is made to be retracted by the solenoid so that the movable member pin 582 is extracted from the notch portion 583. Thus, the locked state of the rotation member 581 is released. Accordingly, the rotation stopped state of the rotary shaft 571 is released, and the developing roller 51 approaches the photosensitive drum 1 so as to come into contact with the photosensitive drum with the rotation of the rotary shaft 571 using the motor.

As described above, according to the embodiment, since the toner compressing corona generator 55 is disposed so as to face the developing roller 51 below the virtual horizontal plane (not shown) passing through the rotary shaft 514 of the developing roller 51 in the vertical direction, when the liquid developing agent which droops and drops from the developing roller 51 adheres to the toner compressing corona generator 55, irregularity of an image occurs. However, in the embodiment, during the developing process, that is, during a time when the developing roller 51 is positioned at the contact position as shown in FIGS. 12 and 13A, the toner compressing corona generator 55 is supported by the developing equipment supporting section 50 in a posture in which the toner compressing corona generator 55 is separated from the virtual perpendicular plane VP5 passing through the rotary shaft 514 of the developing roller 51, that is, the toner compressing corona generator 55 does not intersect with the virtual perpendicular plane VP5. Accordingly, it is possible to prevent the toner compressing corona generator 55 from being contaminated by the liquid developing agent which droops and drops from the developing roller 51.

Further, in the embodiment, the developing equipment supporting section 50 rotates about the rotary shaft 56 so that the developing roller 51 is also positioned at the separation position or the maintenance position other than the developing position. For example, when the developing roller 51 is positioned at the separation position, as shown in FIG. 13B, the toner compressing corona generator 55 is positioned at the right side of the virtual perpendicular plane VP5, and is supported by the developing equipment supporting section 50 in a posture in which the toner compressing corona generator does not intersect with the virtual perpendicular plane VP5. Accordingly, it is possible to prevent the toner compressing corona generator 55 from being contaminated by the liquid developing agent which droops and drops from the developing roller 51. Further, when the developing roller 51 is positioned at the maintenance position, as shown in FIG. 14, the toner compressing corona generator 55 is positioned at the left side of the virtual perpendicular plane VP5, and is supported by the developing equipment supporting section 50 in a posture in which the toner compressing corona generator does not intersect with the virtual perpendicular plane VP5. Accordingly, it is possible to prevent the toner compressing corona generator 55 from being contaminated by the liquid developing agent which droops and drops from the developing roller 51. In this way, in the embodiment, since the toner compressing corona generator 55 is supported by the developing equipment supporting section 50 in a posture in which the toner compressing corona generator does not intersect with the virtual perpendicular plane VP5 even when the developing roller 51 is positioned at any position, it is possible to reliably prevent the toner compressing corona generator 55 from being contaminated by the liquid developing agent and perform the satisfactory developing process without any irregularity of an image.

Further, during a time when the developing roller 51 is positioned at the contact position (the developing position) so as to perform the developing process, as shown in FIGS. 12 and 13A, the liquid developing agent which is scraped out by the roller cleaning blade 512 is conveyed to the upside of the collection portion 541 of the developing agent container 54 in the vertical direction by the inclined members 513 and 522, and freely falls from the lowermost position BP2 of the inclined member 522 in the vertical direction. Further, the liquid developing agent which is scraped out by the cleaning blade 521 is conveyed to the upside of the collection portion 541 of the developing agent container 54 in the vertical direction by the inclined member 522, and freely falls from the lowermost position BP2 of the inclined member 522 in the vertical direction. For this reason, the liquid developing agent (the waste liquid) which is scraped out by the blades 512 and 521 may be collected in the collection portion 541 of the developing agent container 54, and the waste liquid may be collected without being mixed with the new liquid developing agent stored in the storage portion 542.

Further, even when the developing roller 51 is positioned at the separation position (FIG. 13B), as in the case where the developing roller 51 is positioned at the developing position, the liquid developing agent which is scraped out by the roller cleaning blade 512 is conveyed to the upside of the collection portion 541 of the developing agent container 54 in the vertical direction by the inclined members 513 and 522. Further, the liquid developing agent which is scraped out by the cleaning blade 521 is conveyed to the upside of the collection portion 541 of the developing agent container 54 in the vertical direction by the inclined member 522. Then, the liquid developing agent (the waste liquid) freely falls from the lowermost position BP2 of the inclined member 522 in the vertical direction and is collected in the collection portion 541 of the developing agent container 54.

Furthermore, when the developing roller 51 is positioned at the maintenance position (FIG. 14), the liquid developing agent which is scraped out by the roller cleaning blade 512 is conveyed to the upside of the collection portion 541 of the developing agent container 54 in the vertical direction by the inclined member 513. Further, the liquid developing agent which is scraped out by the cleaning blade 521 is conveyed to the upside of the collection portion 541 of the developing agent container 54 in the vertical direction by the inclined member 522. Then, the liquid developing agent (the waste liquid) freely falls from the lowermost positions BP1 and BP2 of the inclined members 513 and 522 in the vertical direction and is collected in the collection portion 541 of the developing agent container 54.

In this way, the “collection path member” of the invention is formed only by two inclined members 513 and 522 at the contact position and the separation position. Further, the “collection path member” of the invention is formed only by the inclined member 513 at the maintenance position. Then, even when the developing roller 51 is positioned at any position, since the developing equipment supporting section 50 supports the developing equipment in a posture in which the lowermost position BP2 of the inclined member 522 (at the maintenance position, the lowermost position BP1 of the inclined member 513) is positioned above the collection portion 541 of the developing agent container 54 in the vertical direction, the liquid developing agent (the waste liquid) which is scraped by the blades 512 and 521 may be reliably collected.

In this way, in the embodiment, the photosensitive drum 1 corresponds to the “latent image carrying drum” of the invention. Further, the intermediate coating roller 52 corresponds to the “supply roller” of the invention. Further, the developing roller 51 and the toner compressing corona generator 55 respectively correspond to the “developing agent carrying roller” and the “charging member” of the invention. Further, the collection portion 541 of the developing agent container 54 corresponds to the “collection portion” of the invention, and the cleaning roller 511 and the roller cleaning blade 512 correspond to the “developing agent carrier cleaning section” of the invention. Further, the cleaning blade 521 corresponds to the “supply roller cleaning member” of the invention.

However, in the above-described embodiments, the rotary shaft 56 is fixed to the apparatus main body frame FM so as to be parallel to the rotary shaft 514 of the developing roller 51, and the developing equipment supporting section 50 is configured to be integrally rotatable about the rotary shaft 56. Then, both end portions of the rotary shaft 514 of the developing roller 51 are axially supported to the side plates 50A and 50B of the developing equipment supporting section 50 at a position comparatively far from the rotary shaft 56. For this reason, it is desirable to improve the rigidity of the side plates 50A and 50B, but both side plates 50A and 50B are not easily synchronized with each other in position. Accordingly, at the contact position, the partial contact of the developing roller 51 may occur. Alternatively, at the separation position or the maintenance position, the liquid developing agent which adheres to the developing roller 51 moves to the shaft end portion and unnecessarily droops from the shaft end portion. Therefore, in the above-described embodiments, as shown in FIGS. 16A to 16C, as the adjusting mechanism which adjusts the positions of the rotary shaft 514 of the developing roller 51 and the rotary shaft 56, two types of structures to be described later are installed in the image forming apparatus.

As the first adjusting mechanism, one end portion of the rotary shaft 56 is fixed to the apparatus main body frame FM through a position adjusting mechanism 59. The position adjusting mechanism 59 moves one end portion of the rotary shaft 56 in the horizontal direction perpendicular to the rotation axis direction of the developing roller 51 by using a bolt 591 which protrudes from the right side of FIGS. 16A to 16C, and moves one end portion of the rotary shaft 56 in the vertical direction by using a bolt 592 which protrudes from the downside in the same drawing. Accordingly, it is possible to adjust the fixation position of one end portion of the rotary shaft 56 with respect to the apparatus main body frame FM. Furthermore, in the embodiment, the position adjustment is performed by the two-axis adjustment, but when the sufficient contact precision of the developing roller 51 may be obtained, the position adjustment may be performed by the single-axis adjustment. Further, the position adjusting mechanism may be also installed in the other end portion of the rotary shaft 56.

Further, in the embodiment, as the second adjusting mechanism, a so-called eccentric bearing 561 with an inner bearing and an outer bearing which is eccentric with respect to the inner bearing is used. That is, one end portion of the rotary shaft 56 axially supports the side plate 50B through the eccentric bearing 561. Accordingly, for example, when the outer bearing indicated by the circle mark in the eccentric bearing 561 in the state shown in FIG. 16B is rotated in the counter-clockwise direction of the drawing so as to be moved to the position indicated in FIG. 16C, the position of the side plate 50B may be delicately adjusted. Furthermore, with regard to the other end portion of the rotary shaft 56, the end portion may axially support the side plate 50A through a general bearing. Alternatively, in the same way as described above, the end portion may axially support the side plate 50A through the eccentric bearing. Furthermore, in the above-described embodiments, the position adjustment using the position adjusting mechanism 59 and the position adjustment using the eccentric bearing are simultaneously used, but the position adjustment may be performed by using only one of them.

Here, the image forming apparatus may include: supply roller which supplies the liquid developing agent to the developing agent carrier; a supply roller cleaning member which cleans the supply roller and collects and conveys the liquid developing agent; and a collection portion which is disposed below the supply roller cleaning member in the vertical direction so as to store the liquid developing agent conveyed by the supply roller cleaning member, wherein when the developing equipment supporting section may support the developing equipment in a posture in which the collection portion is positioned below the supply roller cleaning member in the vertical direction when the developing equipment is supported at the first position and the second position.

As described above, the image forming apparatus may include: a developing agent carrier cleaning section which cleans the developing agent carrier and collects the liquid developing agent and a collection path member which has one end portion disposed higher than the other end portion in the vertical direction and of which one end portion is disposed below the developing agent carrier cleaning member in the vertical direction and the other end portion is disposed above the supply roller cleaning member in the vertical direction.

Further, the axial length of the developing agent carrying roller of the other end portion of the collection path member may be set to be shorter than the axial length of the developing agent carrying roller of the supply roller cleaning member.

Further, the image forming apparatus may include: a first side plate which axially supports one end portion of the developing agent carrying roller; a second side plate which axially supports the other end portion of the developing agent carrying roller; a rotary shaft which has one end portion axially supporting the first side plate and the other end portion axially supporting the second side plate and rotates the developing equipment; and an adjusting mechanism which adjusts the positions of the developing agent carrying roller and the rotary shaft.

Further, one end portion of the rotary shaft may be displaced in the direction perpendicular to the rotary axis direction of the rotary shaft by the adjusting mechanism.

Furthermore, the first position may be set to a position where the latent image carrier and the developing agent carrying roller come into contact with each other, that is, the developing position.

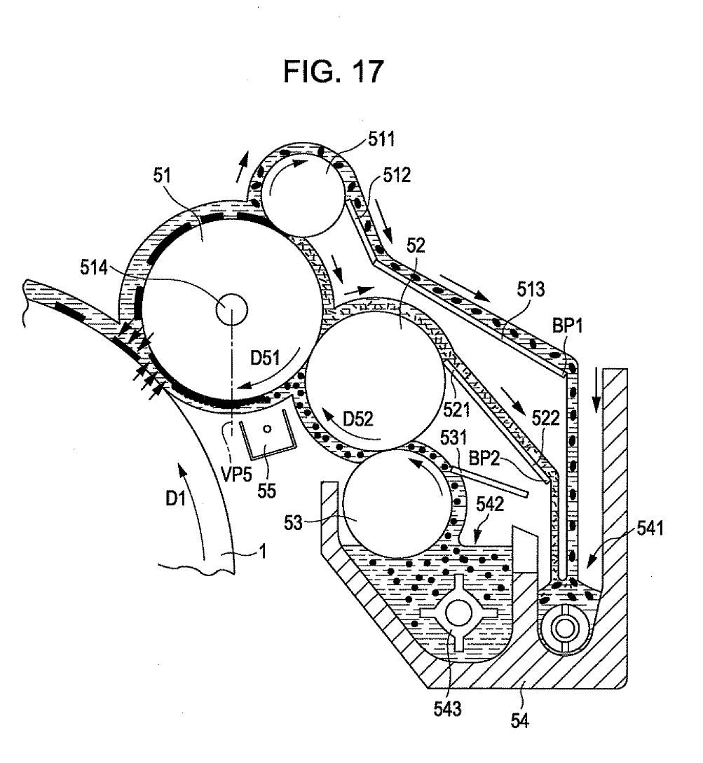

Furthermore, the invention is not limited to the above-described embodiments, and may be modified into various forms without departing from the spirit of the invention. For example, in the above-described embodiments, when the developing roller 51 is positioned to the contact position and the separation position, the liquid developing agent (the waste liquid) which is scraped out by the roller cleaning blade 512 is conveyed to the upside of the collection portion 541 of the developing agent container 54 in the vertical direction by the inclined members 513 and 522. However, for example, as shown in FIG. 17, the inclined member 513 may extend to the upside of the collection portion 541 of the developing agent container 54 in the vertical direction, and the liquid developing agent scraped out by the blade 512 may be directly dropped from the inclined member 513 to the collection portion 541. In this case, only the inclined member 513 corresponds to the “collection path member” of the invention, and the lowermost position BP1 of the inclined member 522 in the vertical direction corresponds to the “lowermost position of the collection path member” of the invention.

Further, in the above-described embodiments, a case has been described in which the invention is applied to an image forming apparatus with a so-called lower transfer structure. However, the invention may be applied to an image forming apparatus with a so-called upper transfer structure which is disposed above the virtual horizontal plane HP passing through the rotation center of the photosensitive drum 1 in the vertical direction so as to transfer an image carried on the photosensitive drum 1.

Furthermore, in the above-described embodiments, the blanket roller 21 is used, but instead of the roller, for example, a belt-like intermediate transfer body may be used.

The entire disclosure of Japanese Patent Application No. 2011-025937, filed Feb. 9, 2011 and No. 2011-031922, filed Feb. 17, 2011 are expressly incorporated by reference herein.

What is claimed is:

1. An image forming apparatus comprising:
a latent image carrying drum on which a latent image is formed;
a charging section that includes a corona charger charging the latent image carrying drum and an air flow duct formed in the corona charger so as to be long in the rotation axis direction of the latent image carrying drum and making air flow in the corona charger; and
a developing section that is disposed above the air flow duct in the vertical direction, is formed so as to be shorter than the air flow duct in the rotation axis direction of the latent image carrying drum, and develops the latent image formed on the latent image carrying drum by a liquid developing agent including toner and a carrier liquid.

2. The image forming apparatus according to claim 1,
wherein a wall portion is disposed above the air flow duct in the vertical direction.

3. The image forming apparatus according to claim 1,
wherein the developing section includes a container storing the liquid developing agent, a pipe making the liquid developing agent flow in the container, and a joint member disposed at one end side of the developing section in the rotation axis direction of the latent image carrying drum and used to attach and detach the pipe, and
wherein the air flow duct is longer than a distance from the joint member to the other side opposite to the one side of the developing section in the rotation axis direction of the latent image carrying drum.

4. The image forming apparatus according to claim 1,
wherein the air flow duct is inclined in a continuous shape or a step shape.

5. The image forming apparatus according to claim 4,
wherein the air flow duct is inclined downward in the vertical direction so as to be separated from the corona charger,
wherein a liquid storage portion of the liquid developing agent is disposed at the opposite end portion of the corona charger, and
wherein a discharge drain is connected to the liquid storage portion.

6. The image forming apparatus according to claim 5,
wherein a collection container is connected to the discharge drain so as to collect the liquid developing agent.

7. The image forming apparatus according to claim 1,
wherein an exposure section that forms the latent image on the latent image carrying drum is disposed between the charging section and the developing section, and
wherein a cover member that covers the upside of the exposure section in the vertical direction is disposed in the air flow duct.

8. A latent image carrying unit comprising:
a latent image carrying drum on which a latent image is formed;
a charging section that includes a corona charger charging the latent image carrying drum and an air flow duct formed in the corona charger so as to be long in the rotation axis direction of the latent image carrying drum and making air flow in the corona charger; and
a developing section that is disposed above the air flow duct in the vertical direction, is formed so as to be shorter than the air flow duct in the rotation axis direction of the latent image carrying drum, and develops the latent image formed on the latent image carrying drum by a liquid developing agent including toner and a carrier liquid.

9. A developing unit that is installed in the image forming apparatus according to claim 1,
wherein the developing section includes
a developing agent carrying roller that carries a liquid developing agent including toner and a carrier liquid,
a charging member that is disposed below a virtual horizontal plane passing through the rotation center of the developing agent carrying roller in the vertical direction so as to charge the liquid developing agent carried on the developing agent carrying roller, and
a developing equipment supporting section that supports the developing section at a first position and a second position different from the first position and supports the developing section in a posture in which the charging member does not intersect with the virtual perpendicular plane when the developing section is supported at the first position and the second position.

10. The image forming apparatus according to claim 1,
wherein the developing section includes
a developing agent carrying roller that carries a liquid developing agent including toner and a carrier liquid,
a charging member that is disposed below a virtual perpendicular plane passing through the rotation center of the developing agent carrying roller in the vertical direction so as to charge the liquid developing agent carried on the developing agent carrying roller,
a support member that supports the developing agent carrying roller and the charging member,
an exposure section that forms the latent image by exposing the latent image carrying drum, and
a developing equipment supporting section that supports the developing section at a first position and a second position different from the first position and supports the developing section in a posture in which the charging member does not intersect with the virtual perpendicular plane when the developing section is supported at the first position and the second position.

11. The image forming apparatus according to claim 10, further comprising:
a supply roller that supplies the liquid developing agent to the developing agent carrying roller;
a supply roller cleaning member that cleans the supply roller and collects and conveys the liquid developing agent; and
a collection portion that is disposed below the supply roller cleaning member in the vertical direction and stores the liquid developing agent conveyed by the supply roller cleaning member,
wherein the developing equipment supporting section supports the developing section in a posture in which the collection portion is positioned below the supply roller cleaning member in the vertical direction when the developing section is supported at the first position and the second position.

12. The image forming apparatus according to claim 11, further comprising:
a developing agent carrier cleaning section that cleans the developing agent carrying roller and collects the liquid developing agent, and
a collection path member of which one end portion is disposed so as to be higher than the other end portion in the vertical direction, the one end portion is disposed below the developing agent carrier cleaning section in the vertical direction, and the other end portion is disposed above the supply roller cleaning member in the vertical direction.

13. The image forming apparatus according to claim 12,
wherein the length of the other end portion of the collection path member in the axial direction of the developing agent carrying roller is shorter than the length of the supply roller cleaning member in the axial direction of the developing agent carrying roller.

14. The image forming apparatus according to claim 11, further comprising:
a first side plate that axially supports one end portion of the developing agent carrying roller;
a second side plate that axially supports the other end portion of the developing agent carrying roller;
a rotary shaft that has one end portion axially supporting the first side plate and the other end portion axially supporting the second side plate and rotates the developing section; and
an adjusting mechanism that adjusts the positions of the developing agent carrying roller and the rotary shaft.

15. The image forming apparatus according to claim 14,
wherein the adjusting mechanism displaces one end portion of the rotary shaft in a direction perpendicular to the rotary axis direction of the rotary shaft.

16. The image forming apparatus according to claim 11,
wherein the first position is a position where the latent image carrying drum and the developing agent carrying roller come into contact with each other.
